(19) United States
(12) Patent Application Publication
(10) Pub. No.: US 2024/0155416 A1
(43) Pub. Date: May 9, 2024

(54) RADIO ACCESS NETWORK (RAN) ENHANCEMENTS FOR UPLINK PROTOCOL DATA UNIT (PDU) SETS

(71) Applicant: QUALCOMM Incorporated, San Diego, CA (US)

(72) Inventors: Linhai HE, San Diego, CA (US); Dario Serafino TONESI, San Diego, CA (US); Sitaramanjaneyulu KANAMARLAPUDI, San Diego, CA (US); Mickael MONDET, Louannec (FR); Prashanth Haridas HANDE, San Diego, CA (US); Diana MAAMARI, San Diego, CA (US)

(21) Appl. No.: 18/497,887

(22) Filed: Oct. 30, 2023

Related U.S. Application Data
(60) Provisional application No. 63/422,304, filed on Nov. 3, 2022.

(51) Int. Cl. H04W 28/02

(52) U.S. Cl. CPC H04W 28/0268; H04W 28/0273

(57) ABSTRACT

A method for wireless communication at a user equipment (UE) includes establishing one or more data radio bearers (DRBs) between the UE and a network node. The method also includes transmitting a protocol data unit (PDU) corresponding to a DRB of the one or more DRBs based at least in part on a mapping of one or more quality of service (QoS) flows to each DRB of the one or more DRBs, each of the one of more QoS flows being associated with one PDU set type of a group of PDU set types or a sub-group of PDU set types of the group of PDU set types.

### CROSS-REFERENCE TO RELATED APPLICATION

The present application claims the benefit of U.S. Provisional Patent Application No. 63/422,304, filed on Nov. 3, 2022, and titled “RADIO ACCESS NETWORK (RAN) ENHANCEMENTS FOR UPLINK PROTOCOL DATA UNIT (PDU) SETS,” the disclosure of which is expressly incorporated by reference in its entirety.

### FIELD OF THE DISCLOSURE

The present disclosure relates generally to wireless communications, and more specifically to radio access network (RAN) enhancements for uplink protocol data unit (PDU) sets.

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BS s) that can support communications for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail, a BS may be referred to as a Node B, an evolved Node B (eNB), a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

A protocol data unit (PDU) set may be specified for a wireless service, such as an extended reality (XR) service. A PDU set is a set of PDUs that may be delivered as an integrated unit to a receiver. For example, a PDU set may be associated with a video frame or a slice within a video frame. In some examples, all PDUs in a same PDU set share common quality of service (QoS) attributes, such as, for example, a PDU set delay budget (PSDB) or a PDU set error rate (PSER). PDU sets may have different decoding criteria (e.g., PDU set content criteria (PSCC)), which may be dependent on an implementation of a given application. A PDU set may be a downlink PDU set or an uplink PDU set.

### SUMMARY

In some aspects of the present disclosure, a method for wireless communication at a user equipment (UE) is disclosed. The method includes establishing one or more data radio bearers (DRBs) between the UE and a network node. The method also includes transmitting a protocol data unit (PDU) corresponding to a DRB of the one or more DRBs based at least in part on a mapping of one or more quality of service (QoS) flows to each DRB of the one or more DRBs. Each of the one of more QoS flows may be associated with one PDU set type of a group of PDU set types or a sub-group of PDU set types of the group of PDU set types.

Other aspects of the present disclosure are directed to an apparatus. The apparatus includes means for establishing one or more DRBs between the UE and a network node. The apparatus also includes means for transmitting a PDU corresponding to a DRB of the one or more DRBs based at least in part on a mapping of one or more QoS flows to each DRB of the one or more DRBs. Each of the one of more QoS flows may be associated with one PDU set type of a group of PDU set types or a sub-group of PDU set types of the group of PDU set types.

In some other aspects of the present disclosure, a non-transitory computer-readable medium with program code recorded thereon is disclosed. The program code is for establish one or more DRBs between the UE and a network node. The program code is executed by one or more processors and includes program code to transmit a PDU corresponding to a DRB of the one or more DRBs based at least in part on a mapping of one or more QoS flows to each DRB of the one or more DRBs. Each of the one of more QoS flows may be associated with one PDU set type of a group of PDU set types or a sub-group of PDU set types of the group of PDU set types.

Some other aspects of the present disclosure are directed to an apparatus. The apparatus having one or more memories, one or more processors coupled to the one or more memories, and instructions stored in the one or more memories. The instructions being operable, when executed by the one or more processors, to cause the apparatus to establish one or more DRBs between the UE and a network node. Execution of the instructions also cause the apparatus to transmit a PDU corresponding to a DRB of the one or more DRBs based at least in part on a mapping of one or more QoS flows to each DRB of the one or more DRBs. Each of the one of more QoS flows may be associated with one PDU set type of a group of PDU set types or a sub-group of PDU set types of the group of PDU set types.

In some other aspects of the present disclosure, a method for wireless communication at a network node is disclosed. The method includes establishing one or more DRBs between the network node and a UE. The method also includes receiving a group of PDUs corresponding to a DRB of the one or more DRBs based at least in part on a mapping of one or more QoS flows to each DRB of the one or more DRBs. Each of the one of more QoS flows may be associated with one PDU set type of a group of PDU set types or a sub-group of PDU set types of a group of PDU set types.

Some other aspects of the present disclosure are directed to an apparatus. The apparatus includes means for establishing one or more DRBs between a network node and a UE. The apparatus also includes means for receiving a group of PDUs corresponding to a DRB of the one or more DRBs based at least in part on a mapping of one or more QoS flows to each DRB of the one or more DRBs. Each of the one of more QoS flows may be associated with one PDU set type of a group of PDU set types or a sub-group of PDU set types of a group of PDU set types.

In some other aspects of the present disclosure, a non-transitory computer-readable medium with program code recorded thereon is disclosed. The program code is for establish one or more DRBs between a network node and a UE. The program code is executed by a processor and includes program code to receive a group of PDUs corresponding to a DRB of the one or more DRBs based at least in part on a mapping of one or more QoS flows to each DRB of the one or more DRBs. Each of the one of more QoS flows may be associated with one PDU set type of a group of PDU set types or a sub-group of PDU set types of a group of PDU set types.

Some other aspects of the present disclosure are directed to an apparatus. The apparatus having one or more memories, one or more processors coupled to the one or more memories, and instructions stored in the one or more memories. The instructions being operable, when executed by the one or more processors, to cause the apparatus to establish one or more DRBs between a network node and a UE. Execution of the instructions also cause the apparatus to receive a group of PDUs corresponding to a DRB of the one or more DRBs based at least in part on a mapping of one or more QoS flows to each DRB of the one or more DRB s. Each of the one of more QoS flows may be associated with one PDU set type of a group of PDU set types or a sub-group of PDU set types of a group of PDU set types.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIGS. 4A, 4B, 4C, 4D, and 4E are block diagrams illustrating examples of different architectures for processing different protocol data unit (PDU) sets at a UE, in accordance with various aspects of the present disclosure.

FIG. 4F is a block diagram illustrating an example of a conventional architecture for processing different protocol data unit (PDU) sets at a UE.

FIG. 5 is a block diagram illustrating an example of a service data adaptation protocol (SDAP) header, in accordance with various aspects of the present disclosure.

FIG. 6 is a block diagram illustrating an example wireless communication device with an architecture that supports protocol data unit (PDU) sets with different quality of service (QoS) attributes, in accordance with various aspects of the present disclosure.

FIG. 7 is a flow diagram illustrating an example process performed by a wireless communication device, in accordance with various aspects of the present disclosure.

FIG. 8 is a block diagram illustrating an example wireless communication device that supports receiving a group of PDUs associated with one or more PDU sets, in accordance with various aspects of the present disclosure.

FIG. 9 is a flow diagram illustrating an example process performed by a network node, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G, 4G technologies, and/or 6G technologies.

A protocol data unit (PDU) set may be specified for a wireless service, such as an extended reality (XR) service. A PDU set is a set of PDUs that may be delivered as an integrated unit to a receiver. For example, a PDU set may be associated with a video frame or a slice within a video frame. In some examples, all PDUs in a same PDU set share common quality of service (QoS) attributes, such as, for example, a PDU set delay budget (PSDB) or a PDU set error rate (PSER).

Still, in some examples, one or more QoS attributes may be different between PDU sets. In some such examples, PDU sets may have different decoding criteria (e.g., PDU set content criteria (PSCC)), which may be dependent on an implementation of a given application. Within a service data flow, there may be different types of data, such as video frame data or audio data. The different decoding criteria may be specified for the different types of data. For example, some PDU sets may be associated with an all or nothing decoding criteria, in which the PDU set may be obsolete if a receiver fails to decode a PDU in the PDU set. As another example, some other PDU sets may be associated with a good until a first loss decoding criteria, in which all received PDUs are valid until the first loss occurs. In yet another example, some other PDU sets may be associated with an application-layer forward error correction (AL-FEC) decoding criteria, in which PDUs in a PDU set are encoded using AL-FEC. In some cases, based on a redundancy ratio of the FEC, only a subset of PDUs in the PDU set may be used to decode the PDU set.

In some examples, one or more PDUs in a PDU set may be discarded by a user equipment (UE) or a radio access network (RAN). In some such examples, the one or more PDUs may be discarded when a delay budget has been exhausted. Alternatively, the one or more PDUs may be discarded if an associated layer-2 timer has expired. The layer-2 timer may be a packet data convergence protocol (PDCP) discard timer, a radio link control (RLC) reassembly timer, an RLC discard timer, or a PDCP reordering time. In some other examples, a PDU may be discarded based on the decoding criteria (e.g., content criteria) associated with the PDU set being satisfied or if the decoding criteria can no longer be satisfied. In some such examples, the decoding criteria may no longer be satisfied if the receiver failed to decode a PDU in the PDU set and the decoding criteria is: all or nothing, or good until the first loss. In other such examples, the decoding criteria may have been satisfied if one or more PDUs in the PDU set have been successfully decoded, such that additional PDUs in the PDU set are no longer necessary.

As discussed, a PDU set may be a downlink PDU set or an uplink PDU set. Both the uplink PDU sets and the downlink PDU sets may include PDU sets with different QoS attributes. Various aspects of the present disclosure are directed to providing an architecture, at a UE, that supports PDU sets with different QoS attributes. In some examples, one or more data radio bearers (DRBs) may be established between the UE and a network node. Additionally, one or more quality of service (QoS) flows may be mapped to each DRB of the one or more DRBs. Each of the one of more QoS flows being associated with one PDU set type of a group of PDU set types or a sub-group of PDU set types of a group of PDU set types. The UE may transmit one or more PDUs associated with one or more PDU sets. Each PDU set may be associated with a sub-QoS flow or a QoS flow.

Particular aspects of the subject matter described in this disclosure can be implemented to realize one or more of the following potential advantages. In some examples, the described techniques, such as establishing one or more data radio bearers (DRBs) between the UE and a network node, and transmitting a PDU corresponding to a DRB of the one or more DRBs based, at least in part, on a mapping of one or more QoS flows to each DRB of the one or more DRBs, may provide an architecture, at a UE, that supports PDU sets with different QoS attributes.

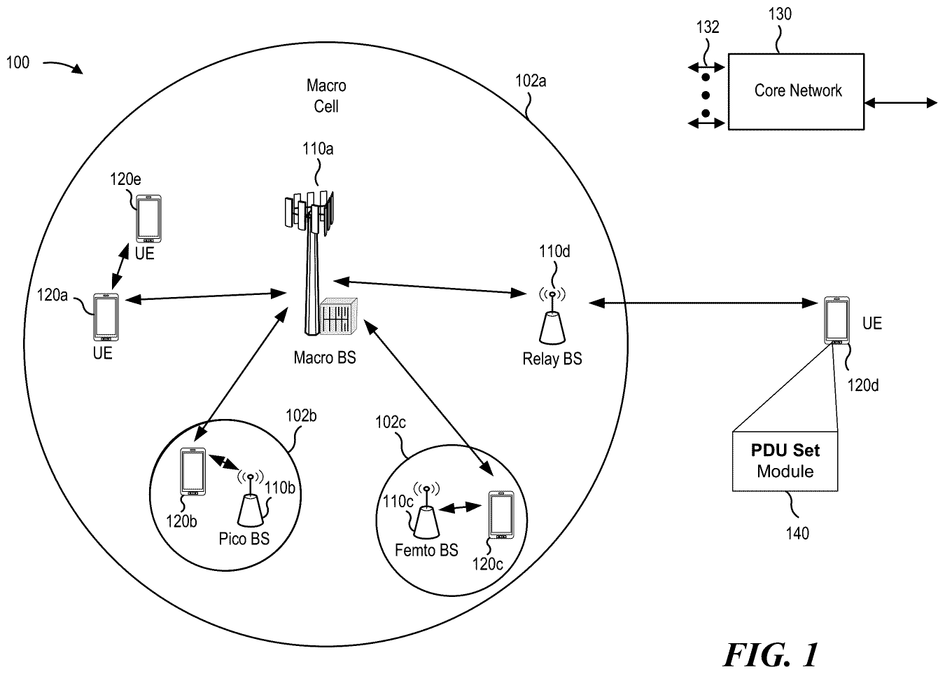

FIG. 1 is a diagram illustrating a network 100 in which aspects of the present disclosure may be practiced. The network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC.

Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station,” “NR BS,” “gNB,” “AP,” “Node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types (e.g., macro BSs, pico BSs, femto BSs, relay BSs, and/or the like). These different types of BSs may have different transmit power levels, different coverage areas, and different impact on interference in the wireless network 100. For example, macro BSs may have a high transmit power level (e.g., 5 to 40 watts) whereas pico BSs, femto BSs, and relay BSs may have lower transmit power levels (e.g., 0.1 to 2 watts).

As an example, the BSs 110 (shown as BS 110a, BS 110b, BS 110c, and BS 110d) and the core network 130 may exchange communications via backhaul links 132 (e.g., S1, etc.). Base stations 110 may communicate with one another over other backhaul links (e.g., X2, etc.) either directly or indirectly (e.g., through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (e.g., S1, S2, etc.) and may perform radio configuration and scheduling for communications with the UEs 120. In some configurations, various functions of each access network entity or base station 110 may be distributed across various network devices (e.g., radio heads and access network controllers) or consolidated into a single network device (e.g., a base station 110).

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

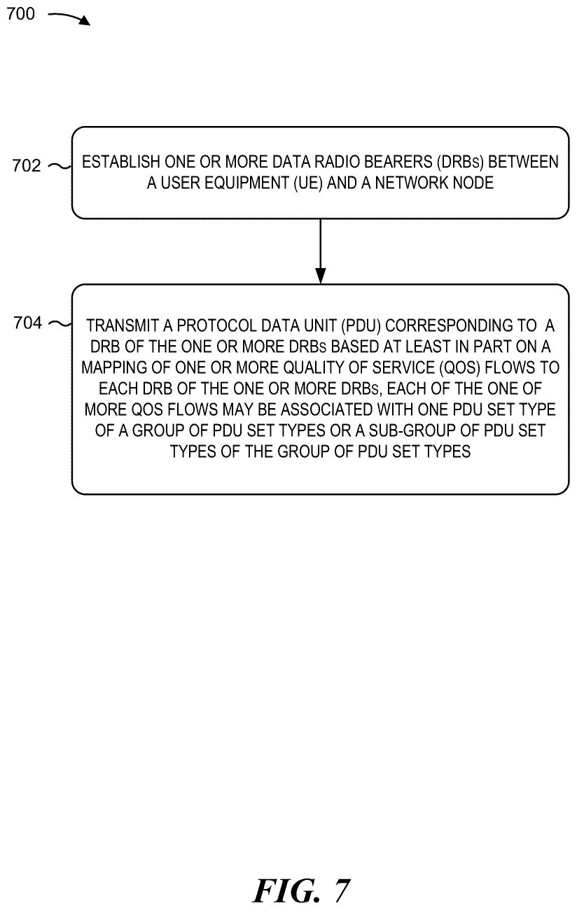

The UEs 120 may include a PDU set module 140. For brevity, only one UE 120d is shown as including the PDU set module 140. The PDU set module 140 may implement one or more steps of the process 700 described with reference to FIG. 7.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (e.g., a system information block (SIB).

As indicated above, FIG. 1 is provided merely as an example. Other examples may differ from what is described with regard to FIG. 1.

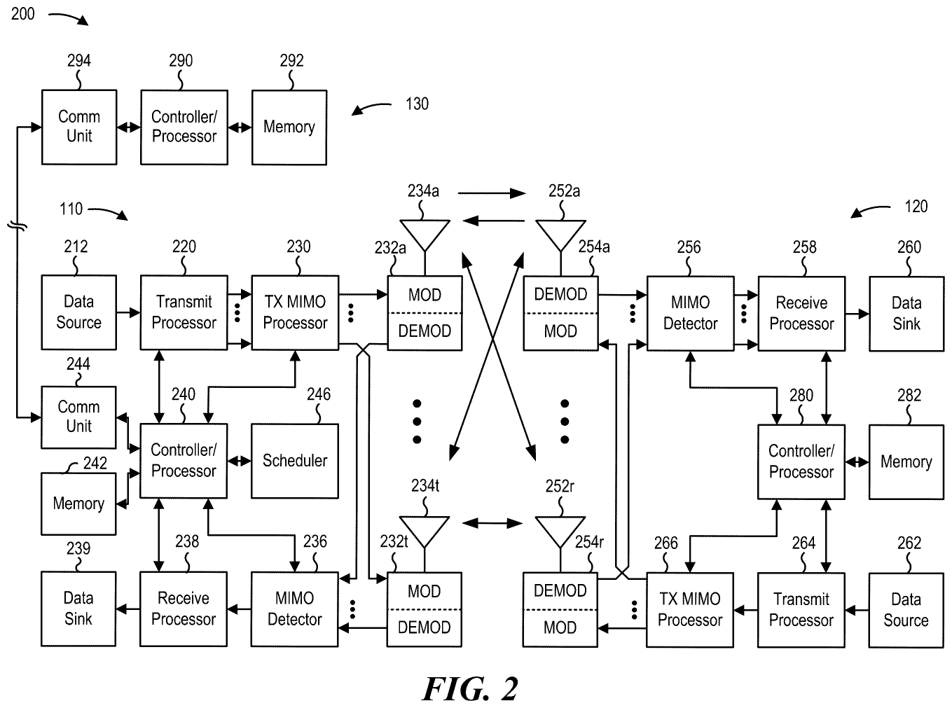

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for orthogonal frequency division multiplexing (OFDM) and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for discrete Fourier transform spread OFDM (DFT-s-OFDM), CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

The controller/processor 240 of the base station 110, the controller/processor 280 of the UE 120, and/or any other component(s) of FIG. 2 may perform one or more techniques associated with supporting PDU sets as described in more detail elsewhere. For example, the controller/processor 240 of the base station 110, the controller/processor 280 of the UE 120, and/or any other component(s) of FIG. 2 may perform or direct operations of, for example, the process of FIG. 7 and/or other processes as described. Memories 242 and 282 may store data and program codes for the base station 110 and UE 120, respectively. A scheduler 246 may schedule UEs for data transmission on the downlink and/or uplink.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some cases, different types of devices supporting different types of applications and/or services may coexist in a cell. Examples of different types of devices include UE handsets, customer premises equipment (CPEs), vehicles, Internet of Things (IoT) devices, and/or the like. Examples of different types of applications include ultra-reliable low-latency communications (URLLC) applications, massive machine-type communications (mMTC) applications, enhanced mobile broadband (eMBB) applications, vehicle-to-anything (V2X) applications, and/or the like. Furthermore, in some cases, a single device may support different applications or services simultaneously.

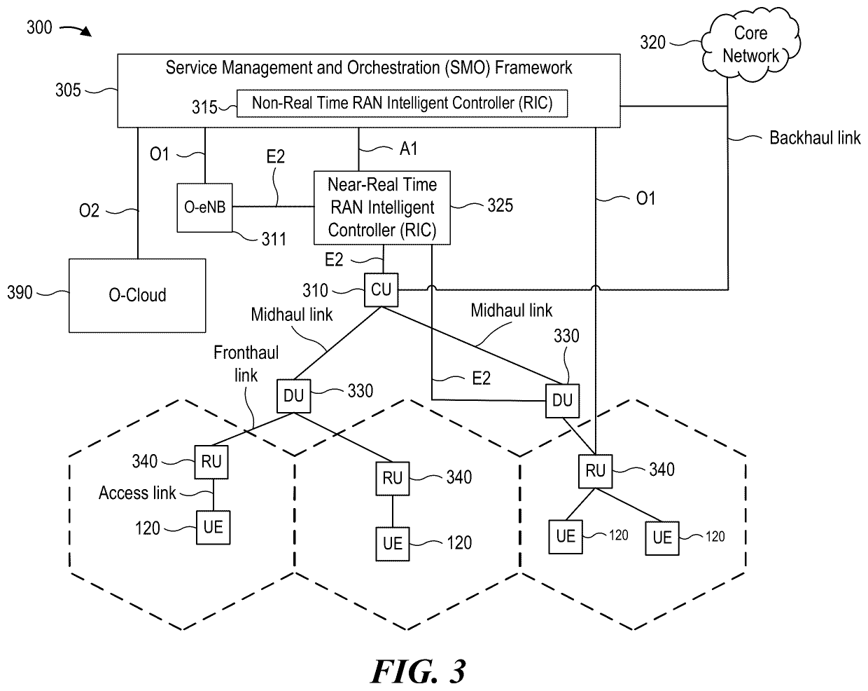

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUs 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., central unit-user plane (CU-UP)), control plane functionality (e.g., central unit-control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO framework 305 may be configured to support RAN deployment and provisioning of non-virtualized and virtualized network elements. For non-virtualized network elements, the SMO framework 305 may be configured to support the deployment of dedicated physical resources for RAN coverage requirements, which may be managed via an operations and maintenance interface (such as an O1 interface). For virtualized network elements, the SMO framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO framework 305 can communicate with a hardware aspect of a 4G RAN, such as an open eNB (O-eNB) 311, via an O1 interface. Additionally, in some implementations, the SMO framework 305 can communicate directly with one or more RUs 340 via an O1 interface. The SMO framework 305 also may include a non-RT RIC 315 configured to support functionality of the SMO framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO framework 305 (such as reconfiguration via 01) or via creation of RAN management policies (such as A1 policies).

A communications protocol stack may be implemented by devices operating in a wireless communication system, such as a 5G system, a 6G system, or a future wireless communication system. The communications protocol stack includes a radio resource control (RRC) layer, a packet data convergence protocol (PDCP) layer, a radio link control (RLC) layer, a medium access control (MAC) layer, and a physical (PHY) layer. In various examples, the layers of a protocol stack may be implemented as separate modules of software, portions of a processor or ASIC, portions of non-collocated devices connected by a communications link, or various combinations thereof.

As discussed, a protocol data unit (PDU) set may be specified for a wireless service, such as an extended reality (XR) service. A PDU set is a set of PDUs that may be delivered as an integrated unit to a receiver. For example, a PDU set may be associated with a video frame or a slice within a video frame. In some examples, all PDUs in a same PDU set share common quality of service (QoS) attributes, such as, for example, a PDU set delay budget (PSDB) or a PDU set error rate (PSER).

In some examples, PDU sets may have different decoding criteria (e.g., PDU set content criteria (PSCC)), which may be dependent on an implementation of a given application. For example, some PDU sets may be associated with an all or nothing decoding criteria, in which the PDU set may be obsolete if a receiver fails to decode a PDU in the PDU set. As another example, some other PDU sets may be associated with a good until a first loss decoding criteria, in which all received PDUs are valid until the first loss occurs. In yet another example, some other PDU sets may be associated with an application-layer forward error correction (AL-FEC) decoding criteria, in which PDUs in a PDU set are encoded using AL-FEC. In some cases, based on a redundancy ratio of the FEC, only a subset of PDUs in the PDU set may be used to decode the PDU set.

In some examples, one or more PDUs may be discarded by a user equipment (UE) or a radio access network (RAN). In some such examples, a PDU may be discarded when a delay budget has been exhausted. Alternatively, the PDU may be discarded if an associated layer-2 timer has expired. The layer-2 timer may be a PDCP discard timer, an RLC reassembly timer, an RLC discard timer, or a PDCP reordering time. In some other examples, a PDU may be discarded based on the decoding criteria (e.g., content criteria) associated with the PDU set being satisfied or if the decoding criteria can no longer be satisfied. In some such examples, the decoding criteria may no longer be satisfied if the receiver failed to decode a PDU in the PDU set and the decoding criteria is: all or nothing, or good until the first loss. In other such examples, the decoding criteria may have been satisfied if one or more PDUs in the PDU set have been successfully decoded, such that additional PDUs in the PDU set are no longer necessary.

In some examples, a PDU set may be a downlink PDU set or an uplink PDU set. Various aspects of the present disclosure are directed to supporting one or more uplink PDU sets at a UE. Uplink PDU sets may share one or more features with downlink PDU sets. In some examples, a packet filter used for downlink PDU set marking may be used for uplink packet filtering. For example, the uplink packet filtering may match a real-time transport protocol (RTP) or a secure RTP (SRTP) header and payload. Additionally, each uplink PDU set may be associated with one or more QoS attributes, such as one or both of a PSDB or a PSER. The PSDB may be an upper bound for a delay between a time when a last PDU in an uplink PDU set is received at an SDAP service access point of a UE and a time when the uplink PDU set is successfully received at a receiver (e.g., network node). The PSER may be an upper bound for a ratio between a number of uplink PDU sets that were not successfully decoded (e.g., received) and a total number of uplink PDU sets sent within a measurement window.

In some examples, the uplink PDU set may include one or more information elements. The one or more information elements may include a PDU set identifier (e.g., sequence number), a boundary indication of an uplink PDU set (e.g., a start and an end of a PDU set), or traffic parameters (e.g., periodicity). Additionally, the one or more information elements may include one or more optional elements, such as a PDU set size represented as bytes or a number of PDUs in the PDU set, an importance of the PDU set, or whether in-order delivery of the PDUs in the PDU set is specified.

In some examples, a PDU set importance is associated with each PDU set instead of a QoS flow. That is, each PDU set may be assigned its own importance level. However, regardless of an importance level, each PDU set with the same QoS flow ID (QFI) may be associated with a same QoS flow. Additionally, in some examples, a PSDB and a PSER may be configured for a QoS flow. The PSDB may be common to all PDU sets associated with a QoS flow. In contrast, the PSER may be measured based on a set of PDU sets transmitted within a time window. Therefore, if a UE selectively discards PDU sets, then PDU sets with a high importance may have a lower PSER than other PDU sets, while the overall error rate still satisfies the PSER. Thus, an importance of a PDU set may be orthogonal to a PSDB associated with the PDU set. Additionally, the importance of the PDU set may be related to a differentiated reliability of decoding the PDU set (e.g., error/loss rate). In some examples, PDU sets associated with a high importance may be more protected than other PDU sets. For example, high importance PDU sets may be selectively duplicated. Additionally, or alternatively, scheduling may be prioritized for high importance PDU sets during uplink congestion to reduce a likelihood that a PDU in a high importance PDU set is discarded due to a delay that is greater than a PSDB.

Various aspects of the present disclosure may discuss a sub-QoS flow and a QoS flow. The sub-QoS flow may be associated with PDUs having a same importance level or PDUs associated with a same PDU set type. A QoS flow may be a conventional QoS flow. Each QoS flow may be associated with a group of sub-QoS flows.

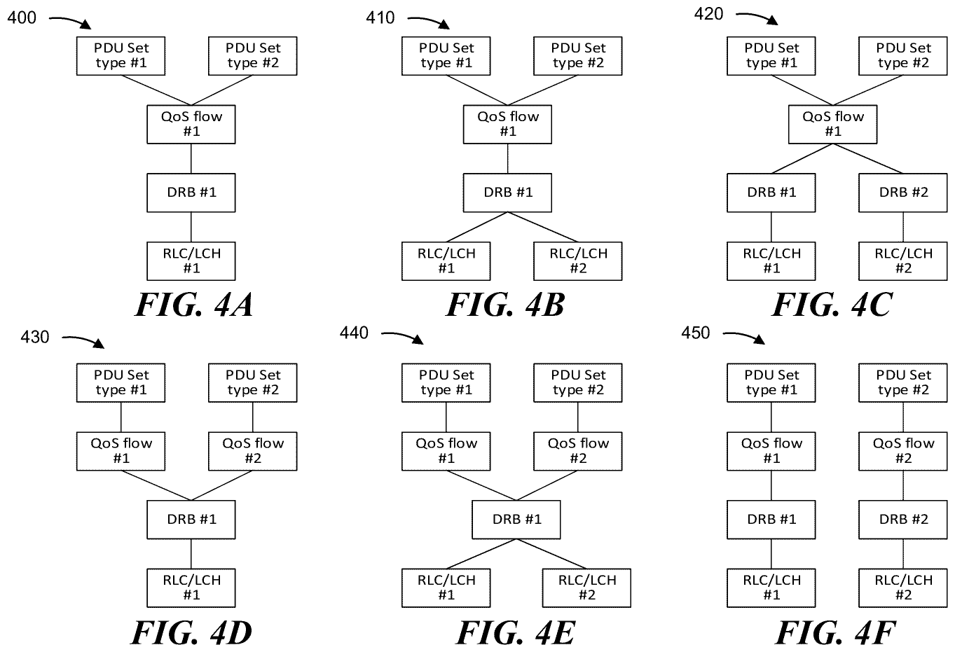

FIG. 4A illustrates an example 400 of an architecture for processing PDU sets at a UE 120, in accordance with various aspects of the present disclosure. In the example 400 of FIG. 4A, two PDU set types (PDU set type 1 and PDU set type 2) may be associated with a same QoS flow (QoS flow 1). Aspects of the present disclosure are not limited to two PDU set types. Additional PDU set types may be associated with the QoS flow. The QoS flow may be mapped to one data radio bearer (DRB) (DRB 1) and the DRB may be associated with a radio link control (RLC) entity (RLC 1). Additionally, the RLC entity may be associated with one logical channel (LCH) (LCH 1). The RLC entity may also be referred to as an RLC layer.

FIG. 4B illustrates an example 410 of an architecture for processing PDU sets at a UE 120, in accordance with various aspects of the present disclosure. In the example 410 of FIG. 4B, two PDU set types (PDU set type 1 and PDU set type 2) may be associated with a same QoS flow (QoS flow 1). The QoS flow may be mapped to one DRB (DRB 1) and the DRB may be associated with two radio link control (RLC) entities (RLC 1 and RLC 2). Additionally, each RLC entity may be associated with an LCH (LCH 1 and LCH 2). Aspects of the present disclosure are not limited to two RLC entities. Additional RLC entities may be associated with the DRB.

FIG. 4C illustrates an example 420 of an architecture for processing PDU sets at a UE 120, in accordance with various aspects of the present disclosure. In the example 420 of FIG. 4C, two PDU set types (PDU set type 1 and PDU set type 2) may be associated with a same QoS flow (QoS flow 1). The QoS flow may be mapped to two different DRBs (DRB 1 and DRB 2). Aspects of the present disclosure are not limited to two DRBs. Additional DRBs entities may be associated with the QoS flow. Each DRB may be associated with a different radio link control (RLC) entity (RLC 1 and RLC 2). Additionally, each RLC entity may be associated with an LCH (LCH 1 and LCH 2).

FIG. 4D illustrates an example 430 of an architecture for processing PDU sets at a UE 120, in accordance with various aspects of the present disclosure. In the example 430 of FIG. 4D, each PDU set type (PDU set type 1 and PDU set type 2) may be associated with a different QoS flow (QoS flow 1 and QoS flow 2). The QoS flows may be mapped to the same DRB (DRB 1). The DRB may be associated with a single radio link control (RLC) entity (RLC 1). Additionally, the RLC entity may be associated with an LCH (LCH 1).

FIG. 4E illustrates an example 440 of an architecture for processing PDU sets at a UE 120, in accordance with various aspects of the present disclosure. In the example 440 of FIG. 4E, each PDU set type (PDU set type 1 and PDU set type 2) may be associated with a different QoS flow (QoS flow 1 and QoS flow 2). The QoS flows may be mapped to the same DRB (DRB 1). The DRB may be associated with two radio link control (RLC) entities (RLC 1 and RLC 2). Additionally, each RLC entity may be associated with an LCH (LCH 1 and LCH 2).

FIG. 4F illustrates an example 450 of a conventional architecture for processing PDU sets at a UE 120. In the example 450 of FIG. 4F, each PDU set type (PDU set type 1 and PDU set type 2) may be associated with a different QoS flow (QoS flow 1 and QoS flow 2). The QoS flows may be mapped to the different DRB s (DRB 1 and DRB 2). Each DRB may be associated with a different radio link control (RLC) entity (RLC 1 and RLC 2). Additionally, each RLC entity may be associated with an LCH (LCH 1 and LCH 2).

FIGS. 4A, 4B, 4C, 4D, and 4E illustrate examples of different architectures for processing different PDU sets at a UE, in accordance with various aspects of the present disclosure. If multiple PDU set types are multiplexed into a common QoS flow, then the multiple PDU set types may share the same QoS attributes, such as the same PSDB, PSER, prioritisedBitRate (PBR), bucketSizeDuration (BSD), and maximum data burst volume (MDBV). If multiple types of PDU set types are multiplexed into different QoS flows (see FIGS. 4D and 4E), then each QoS flow may be associated with its own QoS attributes, even if each PDU set type is associated with the same traffic flow.

Different enhancements may be specified for the different architectures. For example, the architecture examples 400 and 410 described with reference to FIGS. 4A and 4B may use a PDU set type field in an SDAP header associated with a PDU. In some examples, when a PDU arrives at an SDAP service access point (SAP), a UE may identify a sub-QoS flow or QoS flow associated with the PDU based on the SDAP header.

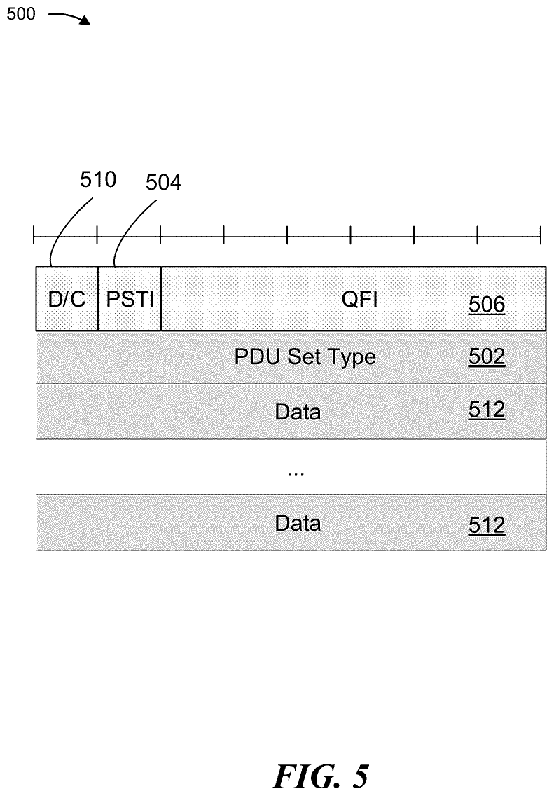

FIG. 5 is a block diagram illustrating an example of a service data adaptation protocol (SDAP) header 500, in accordance with various aspects of the present disclosure. As shown in the example of FIG. 5, the SDAP header 500 may include a PDU set type field 502 that indicates a PDU set type associated with the PDU. In some examples, if a PDU set type is included with a data packet, the UE may include the PDU set type in the PDU set type field 502 of the SDAP header 500 associated with the PDU. Additionally, or alternatively, a PDU set type indicator (PSTI) field 504 may be included in the header to indicate the presence of a value indicating a PDU set type in the PDU set type field 502. Alternatively, if the data packet does not include the PDU set type, the UE may include a QoS flow ID (QFI) in a QFI field 506 of the SDAP header 500. The SDAP header 500 may also include a D/C bit 510. The D/C bit 510 may indicate whether the PDU is a data PDU or a control PDU. The SDAP header 500 may also include one or more data fields 512.

As shown in the examples 400 and 430 described with reference to FIGS. 4A and 4D, respectively, a DRB may be served by a common RLC entity and a common LCH. In the example 400 described with reference to FIG. 4A, different sub-QoS flows may be served by the common RLC entity and the common LCH. In the example 430 described with reference to FIG. 4D, different QoS flows may be served by the common RLC entity and the common LCH. Although different sub-QoS flows or different QoS flows may be served by the common RLC entity and the common LCH, PDUs may be processed differently based one or more parameters associated with a respective PDU type (e.g., PDU set). In the examples 400 and 430 described with reference to FIGS. 4A and 4D, each PDU may be associated with a PDU type. The UE may identity the PDU type based on a PDU set type or a QFI included in an SDAP header of a PDU.

In some examples, the one or more parameters associated with a PDU type may include a set of retransmission timers. A number of PDU retransmissions may be based on the set of retransmission timers. In some examples, the set of retransmission timers may increase a number of PDU retransmissions within an associated delay budget. A reliability of a PDU may increase based on an increase in a number of retransmissions allowed for the PDU. The set of retransmission timers may include one or more retransmission elements, such as maxRetxThreshold, pollPDU, pollByte, t-PollRetransmit. In some examples, pollPDU and pollByte may be defined separately for each PDU set type. The maxRetxThreshold represents a threshold for a maximum number of retransmissions. When determining whether a number of PDUs is greater than or less than the threshold (e.g., maxRetxThreshold), the UE counts PDUs associated with a specific PDU type. In some examples, the one or more parameters associated with the PDU type may include a poll bit indicating that a PDU is an acknowledgment mode (AM) PDU, in which the transmitter is polling (e.g., requesting) the receiving entity about a status of a previously transmitted PDU. In some such examples, the poll bit may be enhanced to indicate a PDU set type associated with the polling. The PDU set type may correspond to one or both of a sub-QoS flow or a QoS flow. In some examples, the one or more parameters associated with the PDU type may indicate whether a UE is allowed to retransmit an RLC PDU, associated with one or both of a sub-QoS flow or a QoS flow, prior to the UE receiving a reception status of the RLC PDU from a receiver. The retransmission indication may be configured via signaling received from a network node.

Additionally, or alternatively, in some examples, the one or more parameters associated with the PDU type may indicate whether out-of-order scheduling (OOOS) is allowed for the PDU type. The one or more parameters may also indicate a delay threshold associated with the PDU type. In such examples, the PDU type may be associated with one or both of a sub-QoS flow or a QoS flow. In some such examples, a UE may prioritize transmission of a PDU configured for OOOS if the PDU is queued behind one or more other PDUs with a lower importance (e.g., priority).

Additionally, or alternatively, in some examples, the one or more parameters associated with the PDU type may indicate that the PDCP PDUs may be duplicated. In such examples, the PDU type may be associated with one or both of a sub-QoS flow or a QoS flow. If duplication is configured, a UE may establish an additional RLC entity and an additional LCH (e.g., duplication RLC entity and duplication LCH) for the duplicated PDCP PDUs. An RLC may duplicate a PDU associated with a sub-QoS flow or QoS flow configured with duplication. Additionally, the RLC may transmit the duplicated PDU to the duplication RLC entity for transmission to a receiver.

As shown in the examples 410 and 440 described with reference to FIGS. 4B and 4E, respectively, the UE determines which of the two or more RLC entities to use based on identifying a PDU set type associated with the PDU. In some examples, such as the example 410 described with reference to FIG. 4B, the PDU set type may be based on a PDU set type field included in an SDAP header associated with the PDU. In some other examples, such as the example 440 described with reference to FIG. 4E, the PDU set type may be determined based on the QFI included in the SDAP header associated with the PDU.

As shown in the examples 410, 420, and 440 described with reference to FIGS. 4B, 4C, and 4E, respectively, the DRB may be associated with two or more RLC entities. In some examples, each RLC entity may be associated with a unique LCH. In some other examples, for each sub-QoS flow or QoS flow, a network node may indicate a mapping between each RLC entity and an LCH. In such examples, multiple RLC entities may be mapped to the same LCH. In some examples, each RLC entity may be associated with a unique set of parameters and timers. As an example, a separate RLC-Config may be specified for each RLC entity. In some examples, the UE may determine which of the two or more RLC entities to use based on identifying a PDU set type (e.g., sub-QoS flow or QoS flow) associated with the PDU.

In some examples, such as the examples 410, 420, and 440 described with reference to FIGS. 4B, 4C, and 4E, respectively, a network node may configure each LCH with a unique set of parameters and timers. The set of parameters may include traffic regulation parameters such as prioritisedBitRate (PBR) and bucketSizeDuration (BSD). Each LCH may maintain a number of tokens in an associated bucket (e.g., Bⱼ) for a corresponding logical channel prioritization (LCP) procedure. Additionally, in some examples, for each LCH, the network node may configure different parameters to assign different transmission attributes to PDU sets with different importance. These parameters may include allowedServingCells, allowedSCS-List, allowedCG-List, allowedPHY-PriorityIndex and mpr-PowerBoost-FR2. In some such examples, PDUs with high importance may only use uplink grants on more reliable cells (e.g., FR1 cells). In other such examples, all PDUs may use frequency range two (FR2) cells, however, PDUs with high importance may use power boost offsets. In some other examples, only PDUs with high importance may use configured grants or uplink grants with high PHY-layer priorities. In some examples, when a UE receives an uplink grant, a conventional LCP procedure may be performed using parameters in the logicalChannelConfig information element (IE) for each LCH.

In some examples, such as the examples 410 and 440 described with reference to FIGS. 4B and 4E, respectively, two or more LCHs may be configured for a DRB. In such examples, each LCH may be associated with a unique set of parameters and timers defined in logicalChannelConfig IEs. Additionally, in such examples, prioritizedBitRate (PBR) and bucketSizeDuration (BSD) may be shared among all LCHs associated with the same QoS flow. In addition, a network node may provide a UE with the association between two or more LCHs and a traffic flow. In some such examples, the UE may maintain a single number of tokens in a bucket Bⱼ for all LCHs associated with a traffic flow j. The parameter Bⱼ may be initialized to zero when the QoS flow is established. Additionally, the parameter Bⱼ may be incremented by (prioritized bit rate (PBR)×min(T, bucket size duration (BSD)) when the UE performs a new uplink transmission, where T is an amount of time elapsed since a last time the parameter Bⱼ was updated.

In some examples, when the UE receives an uplink grant, the UE may select data from different LCHs to multiplex into a physical uplink shared channel (PUSCH) resource. In some such examples, for the parameter Bⱼ, if the traffic flow j is greater than zero, data from all the LCHs associated with this traffic flow may be considered for multiplexing. In other such examples, if the PUSCH does not have enough resources to accommodate data from all the LCHs associated with traffic flow j, then the UE selects a subset of LCHs. This selection may be based on a decreasing order of importance levels associated with the subset of LCHs, or the LCH priorities configured by the network node for the subset of LCHs. If two LCHs have the same priority or importance, then the LCH having data with a smaller delay budget may be selected first. After data from selected LCHs are multiplexed into the PUSCH resource, the UE may decrement the parameter Bⱼ by a total amount of data scheduled from the selected LCHs that are associated with the traffic flow j.

In some examples, such as the example 420 described with reference to FIG. 4C, PDUs within a QoS flow may be split between different DRBs. In such examples, the SDAP layer may identify PDUs with different PDU set types within a QoS flow and then map the identified PDUs to different DRBs. The mapping rule between a PDU set type and a DRB may be configured by the network node in an information element, such as SDAP-Config. In some examples, multiple PDU set types may be mapped to a same DRB.

In some examples, in-order delivery may be specified for a QoS flow. In some such examples, a new protocol layer above the SDAP layer may be used at a receiver. This new protocol layer may reorder data packets before they are delivered to the application layer, because different PDUs in the traffic flow are served by different DRB s and may arrive out of order at the receiver. This reordering procedure may be based on a common reordering function (e.g., the reordering function used for PDCP) or may be based on a PDU set sequence number as the reordering index.

In some examples, PDU set QoS attributes may be configured at a UE. In some such examples, the UE may request QoS rules for an uplink flow. In such examples, the UE may request QoS based rules, for the PDU sets, via a policy control function (PCF). The PCF may determine a PSDB, PSER and PSCC and then provide the PSDB, PSER and PSCC to a session management function (SMF). The SMF may then configure the enhanced QoS rules in UE and 5G-RAN.

In some examples, the UE provides information regarding PDU sets configured at the UE to an SMF. This information may be provided to the SMF via non-access stratum (NAS) signaling. The SMF may then provide the information to a RAN. In some other examples, the UE provides the information about the configured PDU sets directly to the RAN. This information may be included in an RRC message (e.g., UE assistance information), for example.

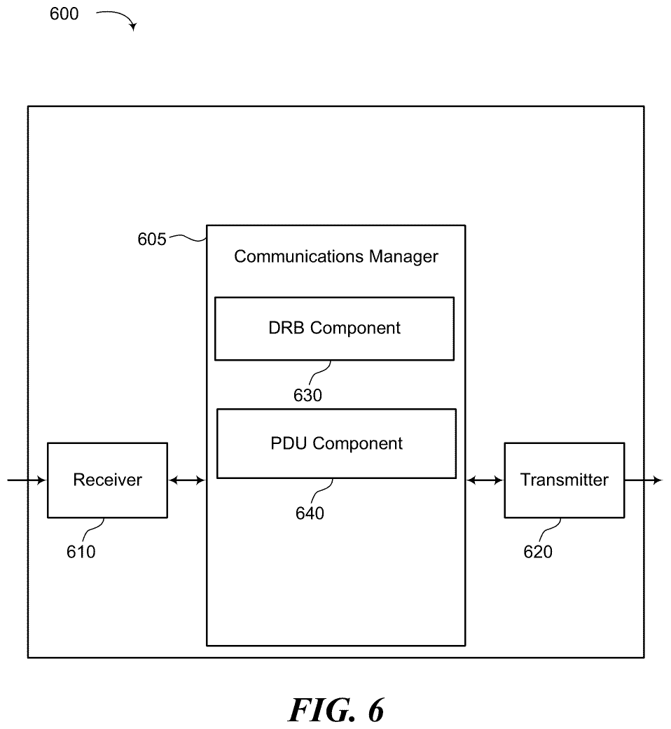

FIG. 6 is a block diagram illustrating an example wireless communication device 600 that provides an architecture that supports PDU sets with different QoS attributes, in accordance with various aspects of the present disclosure. The wireless communication device 600 may be an example of aspects of a UE 120 described with reference to FIGS. 1, 2, and 3. The wireless communication device 600 may include a receiver 610, a communications manager 605, a transmitter 620, a data radio bearer (DRB) component 630 and a PDU component 640 which may be in communication with one another (for example, via one or more buses). In some examples, the wireless communication device 600 is configured to perform operations, including operations of the process 700 described below with reference to FIG. 7.

In some examples, the wireless communication device 600 can include a chip, chipset, package, or device that includes at least one processor and at least one modem (for example, a 5G modem or other cellular modem). In some examples, the communications manager 605, or its sub-components, may be separate and distinct components. In some examples, at least some components of the communications manager 605 are implemented at least in part as software stored in a memory. For example, portions of one or more of the components of the communications manager 605 can be implemented as non-transitory code executable by the processor to perform the functions or operations of the respective component.

The receiver 610 may receive one or more reference signals (for example, periodically configured channel state information reference signals (CSI-RS s), aperiodically configured CSI-RS s, or multi-beam-specific reference signals), synchronization signals (for example, synchronization signal blocks (SSBs)), control information and data information, such as in the form of packets, from one or more other wireless communication devices via various channels including control channels (for example, a physical downlink control channel (PDCCH), physical uplink control channel (PUCCH), or physical sidelink control channel (PSCCH) and data channels (for example, a physical downlink shared channel (PDSCH), physical sidelink shared channel (PSSCH), a physical uplink shared channel (PUSCH)). The other wireless communication devices may include, but are not limited to, a base station 110 as described with reference to FIGS. 1 and 2, a CU 310, DU 330, or RU 340 as described with reference to FIG. 3.

The received information may be passed on to other components of the wireless communication device 600. The receiver 610 may be an example of aspects of the receive processor 256 described with reference to FIG. 2. The receiver 610 may include a set of radio frequency (RF) chains that are coupled with or otherwise utilize a set of antennas (for example, the set of antennas may be an example of aspects of the antennas 252 described with reference to FIG. 2).

The transmitter 620 may transmit signals generated by the communications manager 605 or other components of the wireless communication device 600. In some examples, the transmitter 620 may be collocated with the receiver 610 in a transceiver. The transmitter 620 may be an example of aspects of the transmit processor 266 described with reference to FIG. 2. The transmitter 620 may be coupled with or otherwise utilize a set of antennas (for example, the set of antennas may be an example of aspects of the antennas 252 described with reference to FIG. 2), which may be antenna elements shared with the receiver 610. In some examples, the transmitter 620 is configured to transmit control information in a PUCCH, PSCCH, or PDCCH and data in a physical uplink shared channel (PUSCH), PSSCH, or PDSCH.

The communications manager 605 may be an example of aspects of the controller/processor 259 described with reference to FIG. 2. The communications manager 605 may include the DRB component 630 and PDU component 640. In some examples, working in conjunction with one or both of the receiver 610 and the transmitter 620, the DRB component 630 may, establish one or more DRBs between the UE and a network node. Additionally, working in conjunction with the DRB component 630 and the transmitter 620, the PDU component 640 may transmits a PDU corresponding to a DRB of the one or more DRBs based at least in part on a mapping of one or more QoS flows to each DRB of the one or more DRBs. Each of the one of more QoS flows may be associated with one PDU set type of a group of PDU set types or a sub-group of PDU set types of the group of PDU set types.

FIG. 7 is a flow diagram illustrating an example process 700 performed by a UE 120, in accordance with various aspects of the present disclosure. The example process 700 is an example of a processing PDU sets. As shown in FIG. 7, the process 700 begins at block 702 by establishing one or more data radio bearers (DRBs) between the UE and a network node. At block 704, the process 700 transmits a protocol data unit (PDU) corresponding to a DRB of the one or more DRBs based at least in part on a mapping of one or more QoS flows to each DRB of the one or more DRBs. Each of the one of more QoS flows may be associated with one PDU set type of a group of PDU set types or a sub-group of PDU set types of the group of PDU set types.

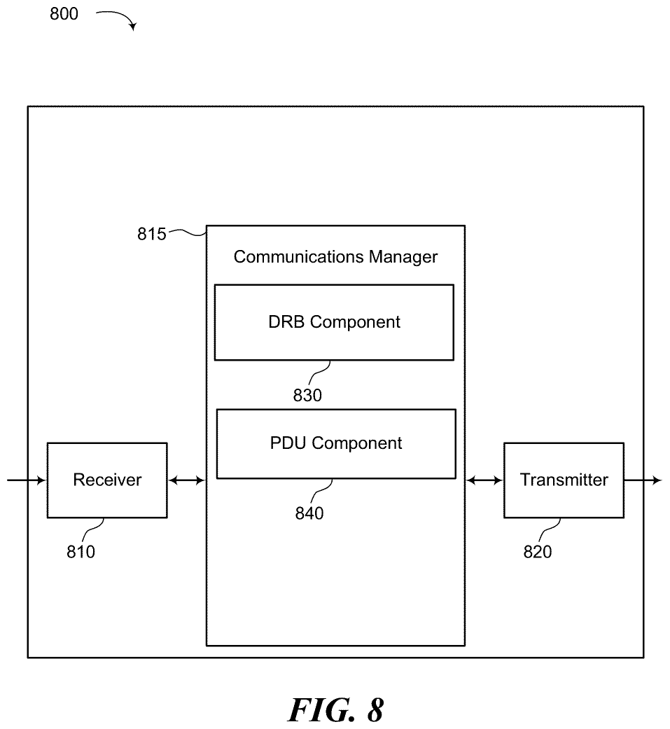

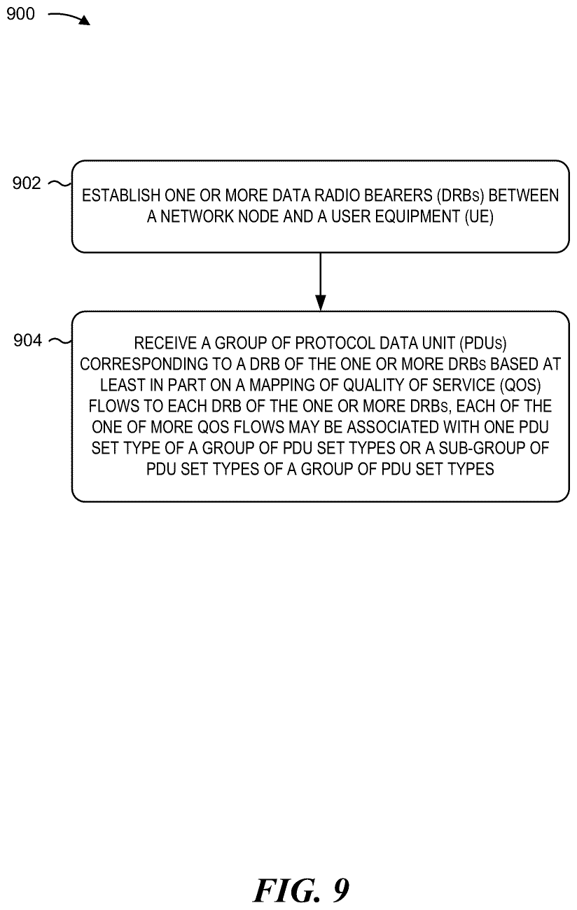

FIG. 8 is a block diagram illustrating an example wireless communication device 800 that supports receiving a group of PDUs associated with one or more PDU sets. The wireless communication device 800 may be an example of a base station 110 as described with reference to FIGS. 1 and 2, a CU 310, DU 330, or RU 340 as described with reference to FIG. 3. The wireless communication device 800 may include a receiver 810, a communications manager 815, a DRB component 830, a PDU component 840, and a transmitter 820, which may be in communication with one another (for example, via one or more buses). In some examples, the wireless communication device 800 is configured to perform operations, including operations of the process 900 described below with reference to FIG. 9.

In some examples, the wireless communication device 800 can include a chip, system on chip (SOC), chipset, package, or device that includes at least one processor and at least one modem (for example, a 5G modem or other cellular modem). In some examples, the communications manager 815, or its sub-components, may be separate and distinct components. In some examples, at least some components of the communications manager 815 are implemented at least in part as software stored in a memory. For example, portions of one or more of the components of the communications manager 815 can be implemented as non-transitory code executable by the processor to perform the functions or operations of the respective component.

The receiver 810 may receive one or more reference signals (for example, periodically configured CSI-RS s, aperiodically configured CSI-RS s, or multi-beam-specific reference signals), synchronization signals (for example, synchronization signal blocks (SSBs)), control information, or data information, such as in the form of packets, from one or more other wireless communication devices via various channels including control channels (for example, a PUCCH or a PSCCH) and data channels (for example, a PUSCH or a PSSCH). The other wireless communication devices may include, but are not limited to, a UE 120, described with reference to FIGS. 1, 2, and 3, or a wireless communication device 402 described with reference to FIGS. 4, 5B, and 5C.

The received information may be passed on to other components of the wireless communication device 800. The receiver 810 may be an example of aspects of the receive processor 238 described with reference to FIG. 2. The receiver 810 may include a set of radio frequency (RF) chains that are coupled with or otherwise utilize a set of antennas (for example, the set of antennas may be an example of aspects of the antennas 234 described with reference to FIG. 2).

The transmitter 820 may transmit signals generated by the communications manager 815 or other components of the wireless communication device 800. In some examples, the transmitter 820 may be collocated with the receiver 810 in a transceiver. The transmitter 820 may be an example of aspects of the transmit processor 220 described with reference to FIG. 2. The transmitter 820 may be coupled with or otherwise utilize a set of antennas (for example, the set of antennas may be an example of aspects of the antennas 234), which may be antenna elements shared with the receiver 810. In some examples, the transmitter 820 is configured to transmit control information in a PDCCH or a PSCCH and data in a PDSCH or PSSCH.

The communications manager 815 may be an example of aspects of the controller/processor 240 described with reference to FIG. 2. The communications manager 815 includes the DRB component 830 and the PDU component 840. In some examples, working in conjunction with one or both of the transmitter 820 and the receiver 810, the DRB component 830 establishes one or more DRBs between the network node and a UE. Additionally, working in conjunction with the receiver 810, the PDU component receives a group of PDUs corresponding to a DRB of the one or more DRBs based at least in part on a mapping of QoS flows to each DRB of the one or more DRBs. Each of the one of more QoS flows may be associated with one PDU set type of a group of PDU set types or a sub-group of PDU set types of a group of PDU set types.

FIG. 9 is a flow diagram illustrating an example process 900 performed by a network node, in accordance with various aspects of the present disclosure. The example process 900 is an example of a receiving a group of PDUs associated with one or more PDU set types. As shown in FIG. 9, the process 900 begins at block 902 by establishing one or more DRBs between the network node and a UE. At block 904, the process 900 receives a group of PDUs corresponding to a DRB of the one or more DRBs based at least in part on a mapping of QoS flows to each DRB of the one or more DRBs. Each of the one of more QoS flows may be associated with one PDU set type of a group of PDU set types or a sub-group of PDU set types of a group of PDU set types.

Implementation examples are described in the following numbered clauses:
Clause 1. A method for wireless communication at a user equipment (UE), comprising: establishing one or more data radio bearers (DRBs) between the UE and a network node; and transmitting a protocol data unit (PDU) corresponding to a DRB of the one or more DRBs based at least in part on a mapping of one or more quality of service (QoS) flows to each DRB of the one or more DRBs, each of the one of more QoS flows being associated with one PDU set type of a group of PDU set types or a sub-group of PDU set types of the group of PDU set types.
Clause 2. The method of Clause 1, wherein the PDU is associated with one QoS flow of the one or more QoS flows.
Clause 3. The method of Clause 2, wherein a PDU set type and a PDU set type indicator are included in a service data adaptation protocol (SDAP) header of the PDU based at least in part on a data packet, associated with the PDU, indicating the PDU set type.
Clause 4. The method of Clause 2, wherein a QoS flow ID (QFI) is included in a service data adaptation protocol (SDAP) header of the PDU based at least in part on a data packet, associated with the PDU, failing to indicate a PDU set type.
Clause 5. The method of Clause 1, wherein the mapping indicates that the one or more QoS flows are associated with a common radio link control (RLC) entity and a common logical channel (LCH).
Clause 6. The method of Clause 5, further comprising identifying a PDU set type, of the group of PDU set types, associated with the PDU based at least in part on an indication of the PDU set type or a QoS flow ID (QFI) included in an SDAP header of the PDU, wherein the PDU is at least one of transmitted or processed based at least in part on one or more parameters associated with the PDU set type.
Clause 7. The method of Clause 6, wherein: the one or more parameters include one or more of a retransmission timer, an acknowledgement mode (AM) poll bit associated with the PDU set type, or a retransmission parameter allowing a retransmission of the PDU prior to receiving a status report from a receiver; and the method further comprises processing the PDU, at the common RLC entity and the common LCH, based at least in part on the one or more parameters.
Clause 8. The method of Clause 6, wherein: the one or more parameters include one or more of an out-of-order scheduling (OOOS) configuration and a corresponding delay threshold; and the method further comprises prioritizing transmitting of the PDU over other PDUs in a queue based at least in part on the OOOS configuration indicating that OOOS is allowed for the PDU.
Clause 9. The method of Clause 6, wherein: the one or more parameters include a duplicate PDU configuration; and the method further comprises: establishing a duplicate RLC entity and a duplicate LCH based at least in part on the duplicate PDU configuration being enabled; duplicating the PDU at the common RLC entity; and transmitting the duplicated PDU via the duplicate RLC entity.
Clause 10. The method of Clause 1, wherein each DRB is mapped to two or more radio link control (RLC) entities.
Clause 11. The method of Clause 10, further comprising: identifying the one PDU set type, of the group of PDU set types, associated with the PDU based at least in part on an indication of the one PDU set type or a QoS flow ID (QFI) included in an SDAP header of the PDU; and processing the PDU with one RLC entity of the two or more RLC entities based at least in part on identifying the one PDU set type.
Clause 12. The method of Clause 1, wherein: each of the one or more QoS flows mapped to each DRB is mapped to a respective RLC entity of one or more RLC entities; and each of the one or more RLC entities is associated with a respective logical channel (LCH) of one or more LCHs.
Clause 13. The method of Clause 1, further comprising receiving, from the network node, a message mapping, for each of the one or more QoS flows mapped to each DRB, each of one or more RLC entities to a logical channel (LCH).
Clause 14. The method of Clause 1, wherein each DRB is associated with a plurality of logical channel (LCHs).
Clause 15. The method of Clause 14, wherein: for a traffic flow, the UE maintains a single variable representing a number of bits prioritized for transmission of data units; the single variable is associated with the plurality of LCHs; the single variable is initialized to zero; and the single variable is incremented when the UE performs a new uplink transmission.
Clause 16. The method of Clause 15, further comprising: multiplexing data, from at least one LCH of the plurality of LCHs, onto a physical uplink shared channel (PUSCH) resource, based on receiving an uplink grant; and decrementing the variable by a total amount of data multiplexed onto the PUSCH resource.
Clause 17. The method of Clause 16, wherein the data is selected from the plurality of LCHs based on the variable being greater than zero.
Clause 18. The method of Clause 16, wherein: the data is from a subset of the plurality of LCHs based at least in part on a size of the PUSCH resource being less than a size of the data from the plurality of LCHs; the subset is selected based on a decreasing order of: a respective importance level associated with each LCH of the plurality of LCHs; or a respective LCH priority associated with each LCH of the plurality of LCHs.
Clause 19. The method of Clause 18, wherein: the subset includes a first LCH associated with a first delay budget based at least in part on the first LCH having a same priority or a same importance as a second LCH from the plurality of LCHs; and the first delay budget is less than a second delay budget associated with the second LCH.
Clause 20. The method of Clause 1, wherein: a first QoS flow of the one or more QoS flows is mapped to a first DRB and a second DRB of the one or more DRBs; and the PDU is mapped to one of the first DRB or the second DRB based on a PDU set type associated with the PDU.
Clause 21. The method of any one of Clauses 1-20, further comprising requesting, via a policy control function (PCF), PDU set based QoS rules for an uplink flow; and receiving, from a session management function (SMF), enhanced QoS rules based on the request for the PDU set based QoS rules.
Clause 22. The method of Clause 21, wherein: the PCF determines one or more of a PDU set delay budget (PSDB), a PDU set error rate (PSER), or PDU set content criteria (PSCC); and the SMF determines the enhanced QoS rules based on the PCF determining one or more of the PSDB, the PSER, or the PSCC.
Clause 23. The method of any one of Clauses 1-22, further comprising transmitting a message, to a session management function (SMF), indicating the group of PDU set types.
Clause 24. The method of Clause 23, wherein the message is transmitted via non-access stratum (NAS) signaling.
Clause 25. The method of Clause 24, wherein the radio access network (RAN) identifies the group of PDU set types based on transmitting the message to the SMF.
Clause 26. The method of any one of Clauses 1-25, further comprising transmitting a message, to a radio access network (RAN), indicating information regarding the group of PDU set types.
Clause 27. The method of Clause 23, wherein the message is transmitted via a radio resource control (RRC) message.
Clause 28. An apparatus comprising one or more processors, one or more memories coupled with the one or more processors, and storing instructions operable, when executed by the one or more processors to cause the apparatus to perform any one of Clauses 1 through 27.
Clause 29. An apparatus comprising at least one means for performing any one of Clauses 1 through 27.
Clause 30. A computer program comprising code for causing an apparatus to perform any one of Clauses 1 through 27.
Clause 31. A method for wireless communication at a network node, comprising: establishing one or more data radio bearers (DRBs) between the network node and a user equipment (UE); and receiving a group of protocol data units (PDUs) corresponding to a DRB of the one or more DRBs based at least in part on a mapping of one or more quality of service (QoS) flows to each DRB of the one or more DRBs, each of the one of more QoS flows being associated with one PDU set type of a group of PDU set types or a sub-group of PDU set types of a group of PDU set types.
Clause 32 The method of Clause 31, wherein: the DRB corresponding to the group of PDUs is associated with a QoS flow specified for in-order delivery; the group of PDUs are re-ordered at a protocol layer prior to delivery to an application layer at the network node; and the reordering is based at least in part on a reordering function used for a packet data convergence protocol (PDCP) or a PDU set sequence number.
Clause 33. The method of Clause 32, wherein the protocol layer is above a service data adaptation protocol (SDAP) layer.
Clause 34. An apparatus comprising one or more processors, one or more memories coupled with the one or more processors, and storing instructions operable, when executed by the one or more processors to cause the apparatus to perform any one of Clauses 31 through 33.
Clause 35. An apparatus comprising at least one means for performing any one of Clauses 31 through 33.
Clause 36. A computer program comprising code for causing an apparatus to perform any one of Clauses 31 through 33.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. An apparatus for wireless communications at a user equipment (UE), comprising:
one or more processors; and
one or more memories coupled with the one or more processors and storing instructions operable, when executed by the one or more processors, to cause the apparatus to:
establish one or more data radio bearers (DRBs) between the UE and a network node; and
transmit a protocol data unit (PDU) corresponding to a DRB of the one or more DRBs based at least in part on a mapping of one or more quality of service (QoS) flows to each DRB of the one or more DRBs, each of the one of more QoS flows being associated with one PDU set type of a group of PDU set types or a sub-group of PDU set types of the group of PDU set types.

2. The apparatus of claim 1, wherein the PDU is associated with one QoS flow of the one or more QoS flows.

3. The apparatus of claim 2, wherein a PDU set type and a PDU set type indicator are included in a service data adaptation protocol (SDAP) header of the PDU based at least in part on a data packet, associated with the PDU, indicating the PDU set type.

4. The apparatus of claim 2, wherein a QoS flow ID (QFI) is included in a service data adaptation protocol (SDAP) header of the PDU based at least in part on a data packet, associated with the PDU, failing to indicate a PDU set type.

5. The apparatus of claim 1, wherein the mapping indicates that the one or more QoS flows are associated with a common radio link control (RLC) entity and a common logical channel (LCH).

6. The apparatus of claim 5, wherein:
execution of the instructions further cause the apparatus to identify a PDU set type, of the group of PDU set types, associated with the PDU based at least in part on an indication of the PDU set type or a QoS flow ID (QFI) included in an SDAP header of the PDU; and
the PDU is at least one of transmitted or processed based at least in part on one or more parameters associated with the PDU set type.

7. The apparatus of claim 6, wherein:
the one or more parameters include one or more of a retransmission timer, an acknowledgement mode (AM) poll bit associated with the PDU set type, or a retransmission parameter allowing a retransmission of the PDU prior to receiving a status report from a receiver; and
execution of the instructions further cause the apparatus to process the PDU, at the common RLC entity and the common LCH, based at least in part on the one or more parameters.

8. The apparatus of claim 6, wherein:
the one or more parameters include one or more of an out-of-order scheduling (OOOS) configuration and a corresponding delay threshold; and
execution of the instructions further cause the apparatus to prioritize transmitting of the PDU over other PDUs in a queue based at least in part on the OOOS configuration indicating that OOOS is allowed for the PDU.

9. The apparatus of claim 6, wherein:
the one or more parameters include a duplicate PDU configuration; and
execution of the instructions further cause the apparatus to:
establish a duplicate RLC entity and a duplicate LCH based at least in part on the duplicate PDU configuration being enabled;
duplicate the PDU at the common RLC entity; and
transmit the duplicated PDU via the duplicate RLC entity.

10. The apparatus of claim 1, wherein each DRB is mapped to two or more radio link control (RLC) entities.

11. The apparatus of claim 10, execution of the instructions further cause the apparatus to:
identify the one PDU set type, of the group of PDU set types, associated with the PDU based at least in part on an indication of the one PDU set type or a QoS flow ID (QFI) included in an SDAP header of the PDU; and
process the PDU with one RLC entity of the two or more RLC entities based at least in part on identifying the one PDU set type.

12. The apparatus of claim 11, wherein:
each of the one or more QoS flows mapped to each DRB is mapped to a respective RLC entity of one or more RLC entities; and
each of the one or more RLC entities is associated with a respective logical channel (LCH) of one or more LCHs.

13. The apparatus of claim 11, wherein execution of the instructions further cause the apparatus to receive, from the network node, a message mapping, for each of the one or more QoS flows mapped to each DRB, each of one or more RLC entities to a logical channel (LCH).

14. The apparatus of claim 11, wherein each DRB is associated with a plurality of logical channel (LCHs).

15. The apparatus of claim 14, wherein:
for a traffic flow, the UE maintains a single variable representing a number of bits prioritized for transmission of data units;
the single variable is associated with the plurality of LCHs;
the single variable is initialized to zero; and
the single variable is incremented when the UE performs a new uplink transmission.

16. The apparatus of claim 15, wherein execution of the instructions further cause the apparatus to:
multiplex data, from at least one LCH of the plurality of LCHs, onto a physical uplink shared channel (PUSCH) resource, based on receiving an uplink grant; and
decrement the variable by a total amount of data multiplexed onto the PUSCH resource.

17. The apparatus of claim 16, wherein the data is selected from the plurality of LCHs based on the variable being greater than zero.

18. The apparatus of claim 16, wherein:
the data is from a subset of the plurality of LCHs based at least in part on a size of the PUSCH resource being less than a size of the data from the plurality of LCHs;
the subset is selected based on a decreasing order of:
a respective importance level associated with each LCH of the plurality of LCHs; or
a respective LCH priority associated with each LCH of the plurality of LCHs.

19. The apparatus of claim 18, wherein:
the subset includes a first LCH associated with a first delay budget based at least in part on the first LCH having a same priority or a same importance as a second LCH from the plurality of LCHs; and
the first delay budget is less than a second delay budget associated with the second LCH.

20. The apparatus of claim 11, wherein:
a first QoS flow of the one or more QoS flows is mapped to a first DRB and a second DRB of the one or more DRBs; and
the PDU is mapped to one of the first DRB or the second DRB based on a PDU set type associated with the PDU.

21. The apparatus of claim 1, wherein execution of the instructions further cause the apparatus to:
request, via a policy control function (PCF), PDU set based QoS rules for an uplink flow; and
receive, from a session management function (SMF), enhanced QoS rules based on the request for the PDU set based QoS rules.

22. The apparatus of claim 21, wherein:
the PCF determines one or more of a PDU set delay budget (PSDB), a PDU set error rate (PSER), or PDU set content criteria (PSCC); and
the SMF determines the enhanced QoS rules based on the PCF determining one or more of the PSDB, the PSER, or the PSCC.

23. The apparatus of claim 1, wherein execution of the instructions further cause the UE to transmit a message, to a session management function (SMF), indicating the group of PDU set types.

24. The apparatus of claim 23, wherein:
the message is transmitted via non-access stratum (NAS) signaling; and
the radio access network (RAN) identifies the group of PDU set types based on transmitting the message to the SMF.

25. The apparatus of claim 1, wherein execution of the instructions further cause the apparatus to transmit a message, to a radio access network (RAN), indicating information regarding the group of PDU set types.

26. A method for wireless communication at a user equipment (UE), comprising:
establishing one or more data radio bearers (DRBs) between the UE and a network node; and
transmitting a protocol data unit (PDU) corresponding to a DRB of the one or more DRBs based at least in part on a mapping of one or more quality of service (QoS) flows to each DRB of the one or more DRBs, each of the one of more QoS flows being associated with one PDU set type of a group of PDU set types or a sub-group of PDU set types of the group of PDU set types.

27. An apparatus for wireless communications at network node comprising:
one or more processors; and
one or more memories coupled with the one or more processors and storing instructions operable, when executed by the one or more processors, to cause the apparatus to:
establish one or more data radio bearers (DRBs) between the network node and a user equipment (UE); and
receive a group of protocol data units (PDUs) corresponding to a DRB of the one or more DRB s based at least in part on a mapping of one or more quality of service (QoS) flows to each DRB of the one or more DRB s, each of the one of more QoS flows being associated with one PDU set type of a group of PDU set types or a sub-group of PDU set types of the group of PDU set types.

28. The apparatus of claim 27, wherein:
the DRB corresponding to the group of PDUs is associated with a QoS flow specified for in-order delivery;
the group of PDUs are re-ordered at a protocol layer prior to delivery to an application layer at the network node; and
the reordering is based at least in part on a reordering function used for a packet data convergence protocol (PDCP) or a PDU set sequence number.

29. The apparatus of claim 28, wherein the protocol layer is above a service data adaptation protocol (SDAP) layer.

30. A method for wireless communication at a network node, comprising:
establishing one or more data radio bearers (DRB s) between the network node and a user equipment (UE); and
receiving a group of protocol data units (PDUs) corresponding to a DRB of the one or more DRBs based at least in part on a mapping of one or more quality of service (QoS) flows to each DRB of the one or more DRBs, each of the one of more QoS flows being associated with one PDU set type of a group of PDU set types or a sub-group of PDU set types of the group of PDU set types.
